(19) United States
(12) Patent Application Publication
(10) Pub. No.: US 2009/0132542 A1
(43) Pub. Date: May 21, 2009

(54) Peer-to-Peer Sharing in Media Management Software

(75) Inventor: Sheng Xu, San Ramon, CA (US)

Correspondence Address: PATENT LAW GROUP LLP, 2635 NORTH FIRST STREET, SUITE 223, SAN JOSE, CA, 95134, US

(73) Assignee: ARCSOFT, INC., Fremont, CA (US)

(21) Appl. No.: 11/943,550

(22) Filed: Nov. 20, 2007

(51) Int. Cl. G06F 17/30

(52) U.S. Cl. 707/10; 707/E17.032

(57) ABSTRACT

A method is provided for a first media management software on a first device to share media with a second media management software on a second device. The method includes receiving user input designating a user of the second media management software for sharing of media, receiving user input designating a media file to be shared with the user of the second media management software, logging onto a server software on a server computer over a network, and learning from the server software if the second media management software is currently logged in with the server software over the network. When the second media management software is currently logged in with the server software, the method further includes learning from the server software an address of the second device and transmitting the media file to the second media management software over the network using the address.

### FIELD OF INVENTION

This invention relates to media management software that allows the user to browse, search, and organize media files.

### DESCRIPTION OF RELATED ART

Media management and cataloging software are more advanced than simple thumbnail browsers. In addition to helping the user browse and sort through her image collection, they also allow the user to catalog her media with keywords, descriptions and categories, ratings, import dates, and creation dates. These tools use a database structure to make image management fast and efficient. Some of them also include basic to advanced image editing, printing, and photo sharing features. The photo sharing feature is typically limited to emailing the media, sending the media to a mobile phone, and uploading the media to a photo sharing website.

iPhoto from Apple Inc. allows the user to create a photo album or an Event on her computer and sent it to a Web Gallery on a website hosted by Apple Inc. iPhoto automatically uploads the photos and creates an interactive page for visitors to view. With the permission of the owner of the Web Gallery, visitors to the Web Gallery can also contribute their own photos. iPhoto synchronizes the user's Web Gallery with the user's iPhoto library on her computer. When others add photos to the Web Gallery, their photos appear in the user's computer. When the user adds a photo to a published album, it's uploaded to the Web Gallery automatically.

### SUMMARY

In one embodiment of the invention, a method is provided for a first media management software on a first device to share media with a second media management software on a second device. The method includes receiving user input designating a user of the second media management software for sharing of media, receiving user input designating a media file to be shared with the user of the second media management software, logging onto a server software on a server computer over a network, and learning from the server software if the second media management software is currently logged in with the server software over the network. When the second media management software is currently logged in with the server software, the method further includes learning from the server software an address of the second device and transmitting the media file to the second media management software over the network using the address.

### BRIEF DESCRIPTION OF THE DRAWINGS

FIG. 1 illustrates a system for peer-to-peer sharing of media files with media management software in one embodiment of the invention.

FIG. 2 is a flow chart of a method for peer-to-peer sharing of media files with media management software in one embodiment of the invention.

FIGS. 3 to 5 are screenshots of a user interface for media management software in one embodiment of the invention.

Use of the same reference numbers in different figures indicates similar or identical elements.

### DETAILED DESCRIPTION OF THE INVENTION

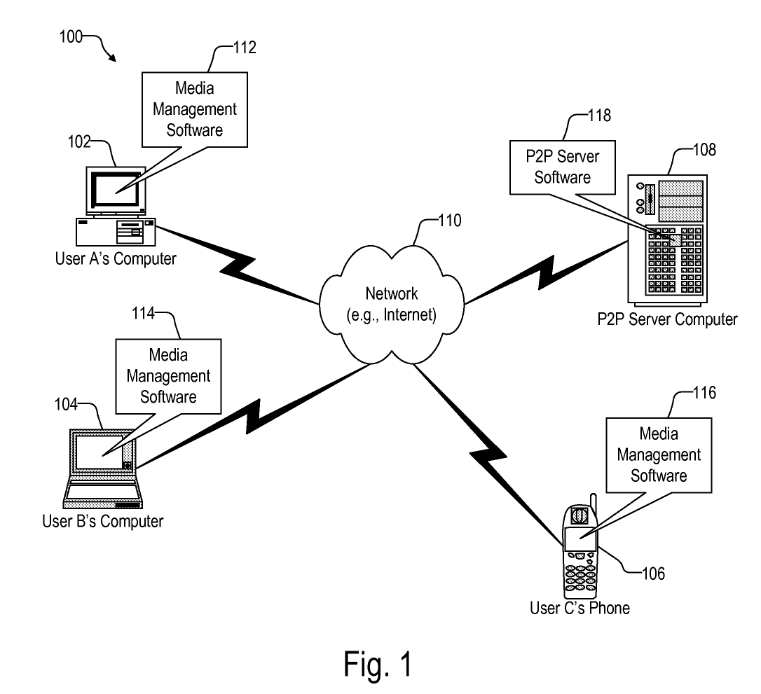

FIG. 1 illustrates a system 100 for implementing peer-to-peer sharing of media between media management software in one embodiment of the invention. System 100 includes a personal computer 102 of a user A, a personal computer 104 of a user B, a mobile phone 106 of a user C, and a server computer 108. All theses devices can be connected to each other through a network 110 (e.g., the Internet). Computer 102 has media management software 112 and computer 104 has media management software 114. Mobile phone 106 has media management software 116 that is the mobile version of the media management software found on computers 102 and 104. Server computer 108 has peer-to-peer (P2P) server software 118 that centrally tracks when media management software 112, 114, and 116 are online and their network addresses.

Like conventional media management software, software 112, 114, and 116 allows the users to browse, search, and organize their media (e.g., photos, music, and videos) using keywords, descriptions, categories, ratings, import dates, and creation dates. Unlike conventional media management software, software 112, 114, and 116 allows the users to share their media by direct transfers between their devices over network 110. For example, user A can specify a media file she wishes to share with user B on media management software 112. In response, media management software 112 queries P2P server software 118 to determine if user B is currently online. When user B is currently online, media management software 112 directly transfers the media file to media management software 114 of user B. This process can occur automatically in the background as user A continues to use media management software 112 to organize her media. For example, user A can add additional media file to a folder or a query that is shared with user B. In response, media management software 112 transfers the newly added media file to media management software 114 of user B in the background when user B is also online.

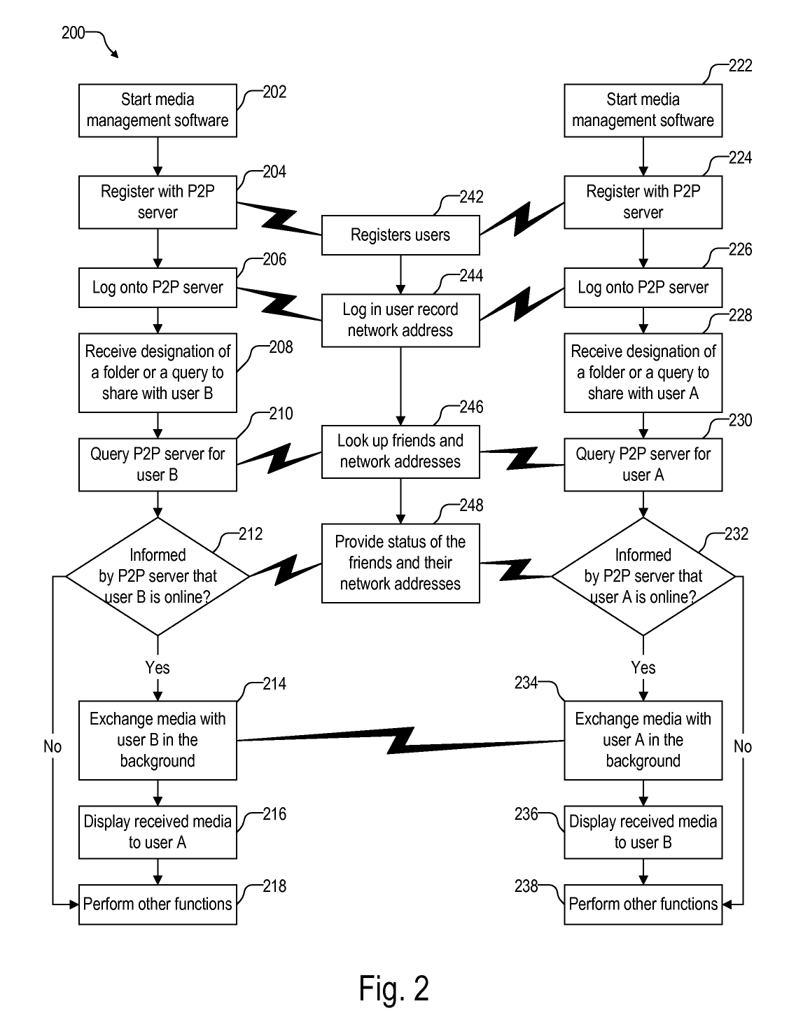

FIG. 2 is a flowchart of a method 200 for user A to use media management software 112 on computer 102 to share media with user B having media management software 114 on computer 104 in one embodiment of the invention. Steps 202 to 218 are performed by media management software 112 on computer 102. Steps 222 to 238 are performed by media management software 114 on computer 104. Steps 242 to 248 are performed by P2P server software 118 on server computer 108.

In step 202, media management software 112 on computer 102 starts to run after user A launches the software.

In step 204, media management software 112 is registered by user A with P2P server software 118 on server computer 108 over network 110. For example, user A provides a user ID (e.g., user A's email address) to register media management software 112 with P2P server software 118. The user ID is used to identify user A and computer 102. Step 204 is only performed once when user A uses media management software 112 for the first time.

In step 206, media management software 112 logs in with P2P server software 118 with the user ID of user A. During the login process, P2P server software 118 can determine the current network address of media management software 112 from the packets received over network 110.

In step 208, media management software 112 receives inputs from user A that specify the media files that are shared, and the friends that the media files are shared with. User A can specify the media files that are shared by selecting a folder containing the media files or a query that returns the media files. An example of a query may be a search for all photos having 5 star rating. User A can specify the friends that the media files are shared with by selecting them from a list of friends registered with P2P server software 118.

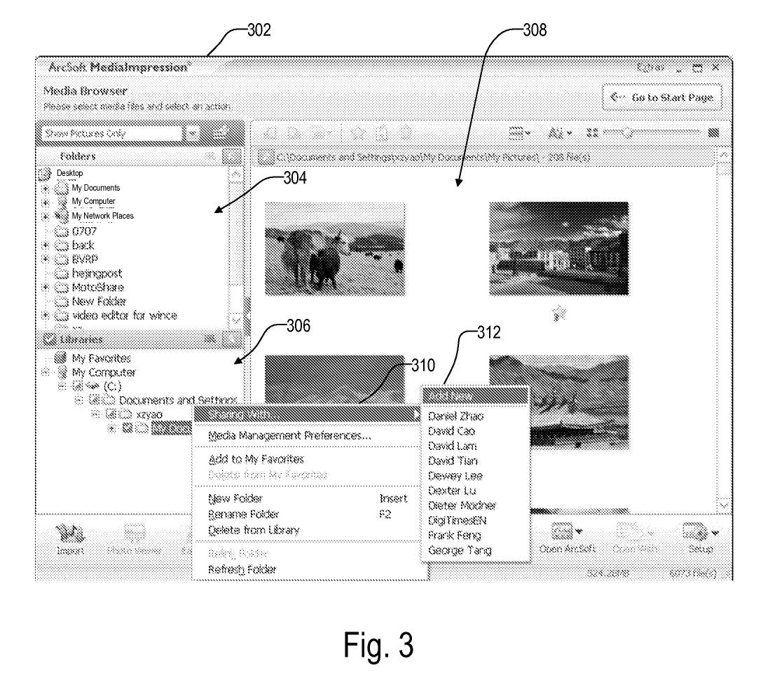

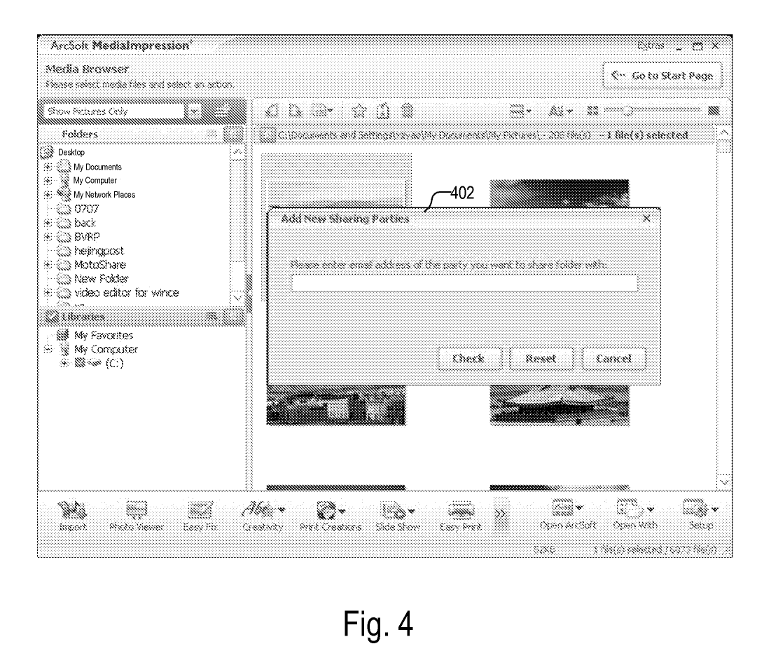

FIGS. 3 and 4 illustrate screenshots of a user interface 302 of media management software 112 that allows user A to specify the media files that are shared, and the friend that the media files are shared with in one embodiment of the invention. As shown in FIG. 3, user interface 302 includes a “Folders” pane 304, a “Libraries” pane 306, and a preview pane 308. Folders pane 304 shows the folders in computer 102. Libraries pane 306 shows the folders that are managed or cataloged by media management software. Preview pane 308 shows previews of the media files in a highlighted or selected folder. A preview of a media file may be a thumbnail of the media files (e.g., a thumbnail of a photo). The preview may also be a short sample of a media file (e.g., a short clip of a song or a video).

To share media files in a folder, user A right clicks the folder in Folders pane 304 or Libraries pane 306 to bring up a menu 310 including a “Sharing With” command, left clicks the “Sharing With” command to bring up a menu 312 with a list of friends registered with P2P server software 118, and left clicks one of the friends.

To add a new friend, user A left clicks an “Add New” command in menu 312 to bring up a dialog box 402 shown in FIG. 4. Dialog box 402 prompts user A to enter the user ID (e.g., the email address) of the new friend. After user A enters the ID of the new friend, media management software 112 queries P2P server software 118 to determine if the new friend is a registered user. When P2P server software 118 replies that the new friend is a registered user, media management software 112 adds the new user to the list of registered friends in menu 312 (FIG. 3). When the new friend is not a registered user, P2P server software 118 sends an email to the new user to prompt her to download a free introductory version of the media management software and register it.

In step 210, media management software 112 queries P2P server software 118 to determine if the specified friend (e.g., user B) is currently online and the network address of user B if she is currently online. User B is currently online when her media management software 114 is running on computer 104 and media management software 114 has logged in with P2P server software 118 over network 110.

In step 212, media management software 112 receives a response from P2P server software 118 that indicates if user B is currently online and the network address of user B when she is currently online. If the response indicates that user B is currently online, then step 212 is followed by step 214. Otherwise step 212 is followed by step 218.

In step 214, media management software 112 transmits the media files that user A wishes to share with user B to media management software 114 over network 110 using the network address of computer 104. If a folder or a query is being shared for the first time, media management software 112 also transmits the folder name or query name to media management software 114 so it can create the appropriate folder or query for holding the media files. To avoid transmitting duplicative media files, folders, and queries, media management software 112 first queries media management software 114 for a list of media files, folders, and queries that were previously transmitted.

At the same time, media management software 112 may receive media files that user B wishes to share with user A. All of this occurs automatically in the background as user A continues to use media management software 112 to organize her media.

In one embodiment, media management software 112 may first send over the previews (e.g., thumbnails or samples) of the media files and then send a specific media file in response to a request from media management software 114 when user B selects the preview to access the media file. Alternatively, media management software 112 may send over the media files after sending over the previews.

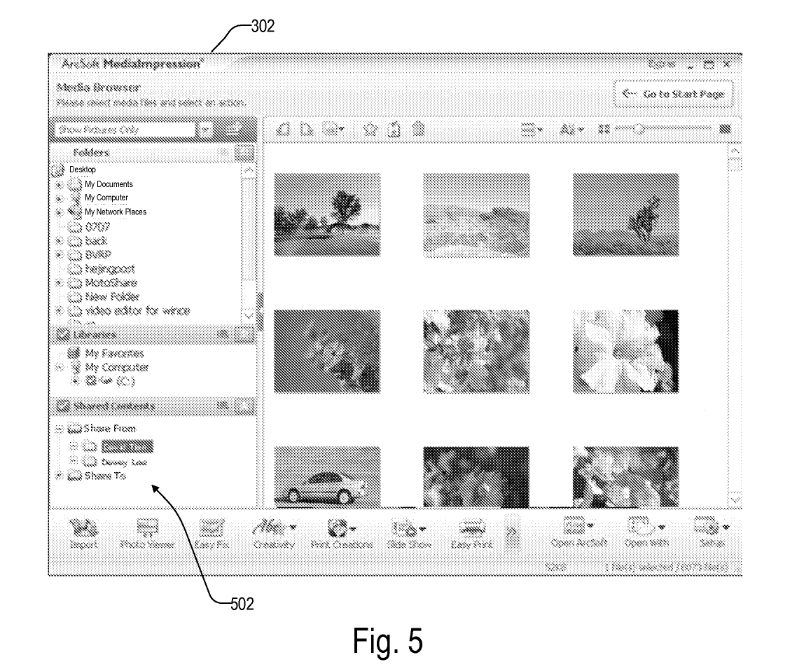

In step 216, media management software 112 updates user interface 302 to display the newly added media files shared between uses A and B. Referring to FIG. 5, user interface 302 includes a “Shared Contents” pane 502 that lists folders and queries shared from other users, and folders and queries shared with other users. Pane 502 lists the shared folders, queries, and media files in a tree structure. As described above, preview pane 308 shows the previews of the media files in a highlighted or selected folder.

In step 218, media management software 112 performs other functions, such as cataloging the media files of user A.

Steps 222 to 238 are performed by media management software 114 on computer 104. These steps mirror steps 202 to 218 described above and are not described in further detail.

In step 222, P2P server software 118 registers users A and B for P2P sharing of media over network 110. Specifically, P2P server software 118 records the user IDs of users A and B provided by their media management software 112 and 114.

In step 242, P2P server software 118 registers first time users (e.g., users A and B) for P2P sharing by recording their user IDs.

In step 244, P2P server software 118 logs in media management software 112 and 114 of users A and B after they provide the correct user IDs over network 110. P2P server software 118 adds users A and B and their network addresses to a list of users that are currently online. P2P server software 118 can determine the network address of users A and B from packets received from media management software 112 and 114 on computers 102 and 104.

In step 246, P2P server software 118 receives queries from media management software 112 and 114 to determine if their friends are currently online, and if so the network addresses of their friends. In response, P2P server software 118 looks up the list users that are currently online for the queried friends.

In step 248, P2P server software 118 informs media management software 112 and 114 whether or not their queried friends are currently online and the network addresses of their media management software when their queried friends are currently online.

Various other adaptations and combinations of features of the embodiments disclosed are within the scope of the invention. Although method 200 has been described for media management software on computers 102 and 104, similar steps can be used between other types of devices to share media files. For example, method 200 can be applied to media management software on computer 102 and mobile phone 106. Numerous embodiments are encompassed by the following claims.

1: A method for a first media management software on a first device to share media with a second media management software on a second device, comprising:
receiving user input organizing media files on the first device;
receiving user input designating a user of the second media management software for sharing of media;
receiving user input designating a media file to be shared with the user of the second media management software;
logging in with a server software on a server computer over a network;
learning from the server software if the user of the second media management software is currently online; and
when the user of the second media management software is currently online:
learning from the server software an address of the second device; and
transmitting the media file to the second media management software over the network using the address.

2: The method of claim 2, further comprising, when the user of the second media management software is currently online:
transmitting a preview of the media file to the second media management software using the address prior to said transmitting the media file, wherein said transmitting the media file occurs when the second media management software requests the media file.

3: The method of claim 2, wherein the preview of the media file is selected from the group consisting of a thumbnail of a photo, a sample of a music, and a sample of a video.

4: The method of claim 1, further comprising, when the user of the second media management software is currently online:
receiving another media file from the second media management software; and
displaying said another media file.

5: The method of claim 1, further comprising, when the user of the second media management software is online:
receiving a preview for another media file from the second media management software over the network; and
displaying the preview of said another media file.

6: The method of claim 5, further comprising:
receiving user input selecting the preview;
requesting said another media file from the second media management software;
receiving said another media file from the second media management software; and
displaying said another media file.

7: The method of claim 1, wherein said receiving user input designating a media file to be shared comprises receiving user input designating a folder to be shared, the folder including the media file.

8: The method of claim 7, further comprising, when the user of the second media management software is online:
transmitting a folder name to the second media management software over the network using the address.

9: The method of claim 1, wherein said receiving user input designating a media file to be shared comprises receiving user input designating a query to be shared, the query being from a search for media files that meet a search parameter of the query.

10: The method of claim 9, further comprising, when the user of the second media management software is online:
transmitting a query name to the second media management software over the network using the address.

11: The method of claim 1, wherein the second device is connected to the server computer over the network and the address is a network address on the network.

12: The method of claim 1, wherein the user of the second media management software is currently online when the second media management software is logged in with the server software.

13: The method of claim 1, further comprising, when the user of the second media management software is online:
querying the second media management software for a list of media files previously transmitted to the second media management software.
